(19) United States
(12) Patent Application Publication
(10) Pub. No.: US 2006/0161481 A1
(43) Pub. Date: Jul. 20, 2006

(54) Luggage selector

(76) Inventor: Richard J. Krulik, Dix Hills, NY (US)

Correspondence Address: ABELMAN, FRAYNE & SCHWAB, 666 THIRD AVENUE, 10TH FLOOR, NEW YORK, NY, 10017, US

(21) Appl. No.: 11/228,451

(22) Filed: Sep. 15, 2005

Related U.S. Application Data
(60) Provisional application No. 60/610,387, filed on Sep. 16, 2004.

(51) Int. Cl. G06Q 30/00

(52) U.S. Cl. 705/26

(57) ABSTRACT

A system and method determine an estimated volume of a user-inputted list of clothing and/or other objects, and use a predetermined selection algorithm for determining at least one article of luggage to be a proposed selection of luggage matching the needs and preferences of the user. The system and method may be implemented using a computer, such as an Internet-based webpage and/or a stand-alone application on a computer not connected to the Internet, for receiving the input information from the user, for processing the input information at a web server using the predetermined selection algorithm, and for outputting to the user the proposed selection of luggage including at least one article of luggage.

### CROSS-REFERENCE TO RELATED APPLICATIONS

This application is based on U.S. provisional application No. 60/610,387, filed on Sep. 16, 2004, now abandoned, which is incorporated herein by reference in its entirety.

### BACKGROUND OF THE INVENTION

1. Field of the Invention

This invention relates to the packing of luggage, and in particular to a system and method for selecting an article of luggage to accommodate a list of selected items to be packed therein.

2. Description of the Related Art

In the prior art, the selection of articles of luggage for packing a list of clothing or other objects has typically been performed by trial and error. In preparation for travel requiring one or more articles of luggage, a traveler may lack sufficient volume in an existing inventory of luggage to accommodate all of the clothing or objects and/or may be uncertain as to which articles of luggage to use. If a traveler becomes a prospective purchaser of a new article of luggage for the upcoming travel, the traveler may inadvertently purchase an article of luggage which is too large or too small for one's itinerary. If the article of luggage is purchased but found to be too large, there may be too much wasted space, and the traveler is presented with the inability to travel with ease or convenience with such needlessly large luggage. Alternatively, if the article of luggage is purchased and is later found to be too small; that is, of insufficient capacity for the immediate needs of the traveler, the traveler may have to resort to stuffing and cramming the clothing and other objects into the insufficiently small luggage, potentially damaging the objects as well as wrinkling or even ruining the clothing.

A need exists for a system and method which facilitate the determination and/or purchase of at least one article of luggage which is just right for the needs of a user.

### BRIEF SUMMARY OF THE INVENTION

A system and method determine an estimated volume of a user-inputted list of clothing and/or other objects, and use a predetermined selection algorithm for determining at least one article of luggage to be a proposed selection of luggage matching the needs and preferences of the user. The system and method may be implemented using a computer, such as an Internet-based webpage and/or a stand-alone application on a computer not connected to the Internet, for receiving the input information from the user, for processing the input information at a web server using the predetermined selection algorithm, and for outputting to the user the proposed selection of luggage including at least one article of luggage.

In one embodiment, a computerized system for selecting luggage for a user includes an input device allowing the user to enter travel information, including possession data corresponding to possessions associated with the user; an output device for outputting a proposed luggage selection for storing the possessions; and a first computer including: a memory for storing the travel information; and a processor for processing the travel information including the possession data for determining an estimated total volume of the possessions, for using a predetermined selection algorithm for determining, from the estimated volume, at least one article of luggage to be the proposed luggage selection, and for transmitting the proposed luggage selection to be output by the output device.

The first computer may be operatively connected to the input device and to the output device. The computerized system may alternatively include a second computer operatively connected to the input device and to the output device, with the first computer being a web server operatively connected to the second computer through the Internet to transmit the proposed luggage selection to the second computer to be output by the output device.

The output device may be a display for displaying the proposed luggage selection. The processor may generate a graphic user interface (GUI) including at least one input field on the display for facilitating user entry of the travel information. The GUI may display a web page having the at least one input field. The GUI may include a browser such as an Internet and/or World Wide Web browser for displaying the web page.

The memory may store a data table including luggage information identifying a plurality of luggage types from which the at least one article of luggage is chosen by the predetermined selection algorithm. The memory may store a plurality of volume estimates, with the processor, responsive to the possession data, matching each of the possessions with a corresponding volume estimate from the plurality of volume estimates for generating the estimated total volume of the possessions.

In another embodiment, a computerized system for selecting luggage for a user includes an input device allowing the user to enter travel information, including possession data corresponding to possessions associated with the user, with the possessions including at least one article of clothing; a display for displaying to the user a proposed luggage selection for storing the possessions including the at least one article of clothing; and a first computer including: a memory for storing the travel information; and a processor for processing the travel information including the possession data for determining an estimated total volume of the possessions, including the at least one article of clothing, for using a predetermined selection algorithm for determining, from the estimated volume, at least one article of luggage to be the proposed luggage selection, and for transmitting the proposed luggage selection to be displayed to the user by the display.

The first computer may be operatively connected to the input device and to the display, with the first computer using the processor for generating the proposed luggage selection independent of the Internet. The computerized system may alternatively include a second computer operatively connected to the input device and to the display, with the first computer being a web server operatively connected to the second computer through the Internet to transmit the proposed luggage selection to the second computer to be displayed by the display.

The processor may generate a GUI including at least one input field on the display for facilitating user entry of the travel information. The GUI may display a web page having the at least one input field. The GUI may include a browser for displaying the web page on the display.

The memory may store a data table including luggage information identifying a plurality of luggage types from which the at least one article of luggage is chosen by the predetermined selection algorithm for storing the at least one article of clothing. The memory may store a plurality of volume estimates, with the processor, responsive to the possession data, matching each of the possessions with a corresponding volume estimate from the plurality of volume estimates for generating the estimated total volume of the possessions, including the at least one article of clothing.

In a further embodiment, a computerized method for selecting luggage for a user includes the steps of: receiving travel information at an input device from a user, with the travel information including possession data corresponding to possessions associated with the user, with the possessions including at least one article of clothing; storing the travel information in a memory of a first computer; processing the travel information including the possession data using a processor of the first computer; determining an estimated total volume of the possessions, including the at least one article of clothing; determining, using a predetermined selection algorithm, at least one article of luggage from the estimated volume, with the at least one article of luggage being the proposed luggage selection; transmitting the proposed luggage selection; and displaying on a display to the user the transmitted proposed luggage selection for storing the possessions including the at least one article of clothing.

The computerized method may also include the steps of: operatively connecting the first computer to the input device; operatively connecting the first computer to the display; and additionally having the step of generating the proposed luggage selection include the step of: generating the proposed luggage selection at the first computer using the processor independent of the Internet.

The computerized method may also include the steps of: operatively connecting a second computer to the input device; operatively connecting the second computer to the display; and having a web server as the first computer operatively connected to the second computer through the Internet to transmit the proposed luggage selection to the second computer to be displayed by the display.

### BRIEF DESCRIPTION OF THE SEVERAL VIEWS OF THE DRAWINGS

Preferred embodiments of the invention are disclosed hereinbelow with reference to the drawings, wherein:

FIG. 1 is a schematic of a first embodiment of a computer and Internet-based system implementing the present invention;

FIG. 2 is a schematic of a second embodiment of a stand-alone computer implementing the present invention; and

FIG. 3 is a flowchart of operation of the present invention.

### DETAILED DESCRIPTION OF THE INVENTION

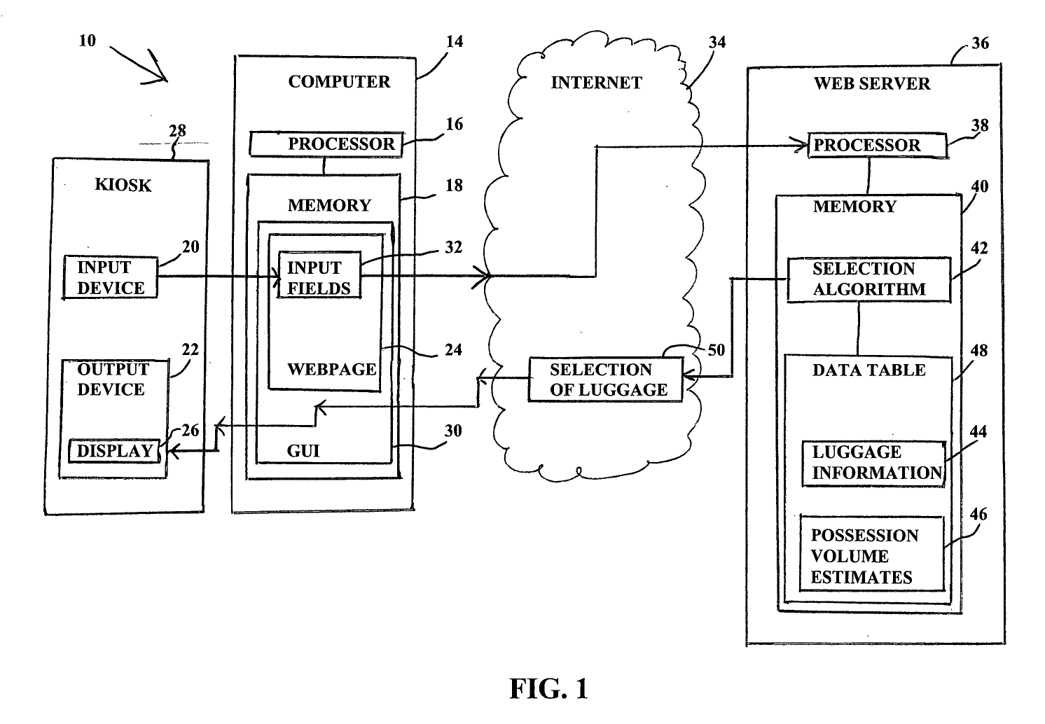

As described herein, a system 10 and method 12 are disclosed, for example, as implemented in an example embodiment shown in FIGS. 1-3, respectively, for selecting an article of luggage to accommodate a list of selected items to be packed therein, such as articles of clothing to be fitted within the selected luggage.

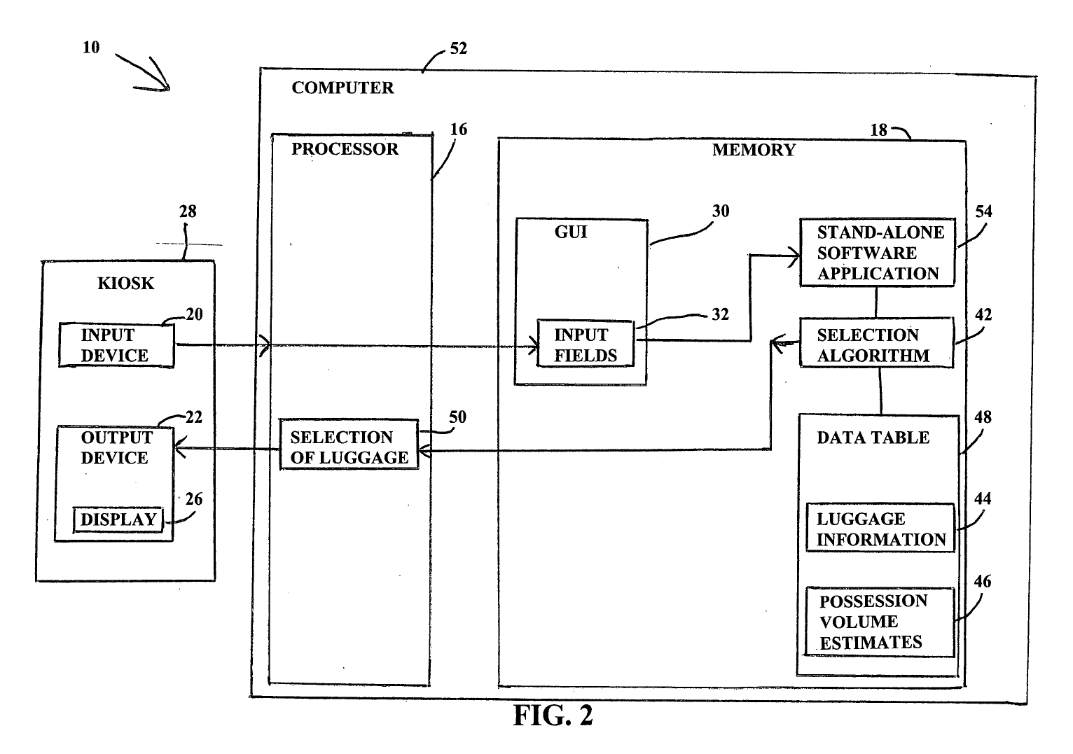

In a preferred embodiment, the disclosed system 10 and method 12 are implemented using a computer 14 having a processor 16 and a memory 18, and including or operatively connected to a known input device 20 and a known output device 22 including, for example, a display 26. The input device 20 and the output device 22 may be distinct components, or may optionally be combined in a single input/output device, such as a kiosk 28 or a remote terminal connected to the computers 14, 52 in FIGS. 1-2, respectively. For example, the kiosk 28 may be provided on the sales floor in the store of a luggage vendor, and may be operatively connected to either of the computers 14, 52 in a computer room of the store.

The disclosed system 10 and method 12 may be implemented using a webpage 24 generated in the memory 18 by the processor 16 and displayed on the display 26 through a graphic user interface (GUI) 30, with the webpage 24 having at least one input field 32 for receiving information input into the input device 20 from a user. The GUI 30 may include any known browser such as an Internet and/or World Wide Web browser including, for example, commercially available “INTERNET EXPLORER” browser software from “MICROSOFT CORPORATION”.

In an example embodiment, the computer 14 may be a personal computer commercially available from “DELL CORPORATION”, running as an operating system “WINDOWS XP” commercially available from “MICROSOFT CORPORATION”, with the processor 16 being a “PENTIUM” microprocessor commercially available from “INTEL CORPORATION”, with the input device 20 being a keyboard and/or a mouse, and with the output device 22 being a printer commercially available from “HP CORPORATION” and/or with the display 26 being a cathode ray tube (CRT) monitor or a flat screen monitor. It is understood that any known components and devices may be used to implement the present invention with the computer 14 and other devices described herein.

Such received information in the input fields 32 is then transmitted over the Internet 34 to a web server 36 having a processor 38 and a memory 40, with the received information processed by the processor 38 using a predetermined luggage selection algorithm 42, for example, implemented as software stored in the memory 40 of the web server 36. For example, the predetermined luggage selection algorithm 42 may be written in the C++ programming language.

The predetermined luggage selection algorithm 42 accesses diverse types of luggage information 44 and possession volume estimates 46 stored, for example, in at least one data table 48 in the memory 40, to determine at least one article of luggage to be a selection 50 of luggage corresponding to the user-inputted information. The data table 48 may be embodied as a database such as the “ACCESS” database software commercially available from “MICROSOFT CORPORATION”.

The information identifying the at least one determined article of luggage as the luggage selection 50 is then relayed back to the user from the web server 36 and through the Internet 34 to be output by the computer 14 of the user, for example, on the webpage 24 through which the user inputted the list of possessions to be packed in the at least one input field 32.

In another example of the disclosed system 10 and method 12 shown in FIG. 2, a computer 52 is a stand-alone computer which is not required to be connected to the Internet 34 or to any web server to generate the luggage selection 50, although the computer 52 may optionally be connected to the Internet 34 or a web server for other operations, such as searching for vendors of luggage to match the luggage selection 50. The computer 52 includes the processor 16 and memory 18, and is connected to the input device 20 and the output device 22 having the display 26. The processor 16 of the computer 52 executes a stand-alone software application 54 in the memory 18 independent of the Internet 34 and any web server 36, such that the stand-alone software application 54 receives and processes the user-inputted information using the predetermined luggage selection algorithm 42 in the memory 18 to determine at least one article of luggage as a luggage selection 50 corresponding to the user-inputted information. The information identifying the determined at least one article of luggage is then output by the computer 52 to the user, for example, through the screen on the display 26 through which the user inputted the information in the at least one input field 32.

The computer 14 operating the webpage 24 through a browser and/or the computer 52 operating the stand-alone software application 54, shown in FIGS. 1-2 respectively, display a screen on the display 26 to provide the GUI 30 using, for example, a mouse and/or a keyboard as the input device 20, and the display 26 as the output device 22, with the GUI 30 displayed on the display 26 acting as a combination input/output device, with a cursor or other images operating in conjunction with user operation of the mouse and/or keyboard to select and modify the input fields 32 and the data inputted therein. The input fields 32 are displayed through the GUI 30 and may include pull-down menus of predetermined text and/data values available to be selected by the user, icons implementing radio-type buttons on the GUI 30 with such buttons substantially adjacent to displayed text and/data values available to be selected by the user, mouse-actuated icons having displayed images and/or text, or other known input techniques allowing the user to select or otherwise input data to be processed by the disclosed system 10 and method 12.

In both examples of the computerized system 10 and method 12 shown in FIGS. 1-2, each of the computers 14, 52 of FIGS. 1-2, respectively, may be a personal computer, a laptop, a personal digital assistant (PDA), a web-enabled cell phone, and/or any other known computing device for implementing the disclosed computerized system 10 and method 12.

The outputted at least one determined article of luggage as the selection 50 of luggage is displayed as text and/or images on the display 26 connected to or associated with the respective computers 14, 52 for viewing by the user. Alternatively or in addition, the output device 22 of the disclosed system 10 and method 12 may also include a printer for generating and outputting a hardcopy text and/or image to the user of corresponding articles of luggage as the selection 50 of luggage. For example, the hardcopy may be generated at each of the computers 14, 52 in the home and/or at a luggage store, and the user may then browse various articles of luggage for the appropriate selection 50 of luggage to accommodate the items specified by the inputted information from the user corresponding to articles of clothing or other items to be fitted within the selected luggage 50.

In addition, in both examples of the computerized system 10 and method 12 using an Internet-based processing of user-inputted information or a stand-alone software application, as described in connection with FIGS. 1-2, respectively, the user may save in the memory 18, 40 of the respective computers 14, 52 the inputted information and/or the outputted luggage selection 50 corresponding to the inputted information. The user may then modify the inputted information to vary the selections of articles of clothing to be packed and/or the travel conditions or preferences of the user, as described herein, and thus to determine new selections 50 of articles of luggage using the predetermined selection algorithm 42.

Accordingly, the disclosed computerized system 10 and method 12 facilitate the selection process for packing luggage for travel as well as facilitating the purchasing process to obtain the appropriate and/or optimal luggage in preparation for packing for travel, by applying the information processing abilities of computers to provide a quantifiable format for the selection and/or purchase of articles of luggage to meet the needs of the user.

In an alternative embodiment, the predetermined selection algorithm 42 may be implemented without computers, for example, using mechanical spinning wheels composed of printed and interconnected paper of the type used for selecting food in diet plans. In a further embodiment, the predetermined selection algorithm 42 may be implemented in a book, such as a workbook and/or a book having text and pages to which the user is directed according to user selections, with fillable worksheets and tables of volume calculations, including conversion of metric and English units of length and volume.

Referring to FIGS. 1-2, to perform the predetermined selection algorithm 42 for luggage selection, the disclosed computerized system 10 and method 12 includes a data table 48 or database stored in each of the memories 18, 40 having luggage information 44 which specifies the dimensions, volumes, characteristics, and categories of a plurality of articles of luggage. For example, a specific model of a carry-on suitcase may be specified with dimension in inches or centimeters, and an internal volume of storage capacity in cubic inches or cubic decimeters.

The computerized system 10 and method 12 allow the user to input, in the at least one input field 32, specific information about the types of articles of clothing and the conditions of a planned travel itinerary. The user may be selecting the luggage for oneself, for various members of the family of the user, for friends, or other associates and/or companions. Alternatively, the user may be a prospective customer in a store of a luggage vendor, or alternatively the user may be a salesperson assisting a prospective customer, with the user being given the opportunity to utilize the computerized system 10 and method 12 within the store and using, for example, computer equipment accessible in the store, to guide the purchase of at least one article of luggage as the selection 50 of luggage, for example, for a planned trip.

For example, the user may input one or more of the following: the number of days of travel; the number of people traveling; the number of women, men, and children traveling; whether the travel itinerary is during the summer, spring/fall, winter, or other times or months of year; whether the proposed travel itinerary is to a hot, warm, or cold climate; whether the traveler is a light packer or a heavy packer, that is, whether the traveler tends to minimize or maximize the articles of clothing during a trip; whether the user desires an article of luggage to be large or small; whether the user desires to use an article of luggage classified and/or dimensioned as a carry-on bag, for example, in an airplane or passenger train; whether the user prefers the fewest number of bags classified generally as large luggage, or whether the user prefers an assorted number of medium or small size bags; whether none, some, or many of the articles of clothing are to include hanging garments; whether extra space is to be allocated for purchases during the trip such as souvenirs or gifts for family and/or friends; and any other known criteria which may be a factor to determine the size and dimensions of the articles of luggage to be selected.

Based on at least some of the input information recited herein, the predetermined selection algorithm 42 generates a proposed list of clothing which the user may keep the same or may adjust. The disclosed computerized system 10 and method 12 may also incorporate default minimum settings for the number of articles of clothing per person per day of travel. For example, for every day of travel specified by the user, the system 10 and method 12 may automatically list a minimum of two pairs of shoes and optional an extra pair of shoes per every three days of travel; one pair of underwear per day; if travel is during the winter, one sweater per two days; if travel is during the summer, no sweaters per day; one pair of shorts per day if the travel itinerary is during the summer; one pair of pants per three days of travel in the summer; but one pair of pants per day of travel in the winter; etc.

The user may change the number of clothes, or cancel any type of article of clothing. For example, although the travel itinerary is during the winter, the travel location may be a warm climate such as the Caribbean, so sweaters may be set to be zero per day. The computerized system 10 and method 12 may also account for the reversed winter months and summer months in the Southern Hemisphere compared to the designated summer and winter months in the Northern Hemisphere.

In addition to articles of clothing, the computerized system 10 and method 12 may also allow the user to input non-clothing related items, such as cameras, gifts for friends or business acquaintances, laptops, cell phones, passports, toiletries, or any other objects which the user may choose to pack.

For articles of clothing and/or for non-clothing objects to be packed, the computerized system 10 and method 12 may store default estimates 46 of the volume of each item to be packed. For example, for cold weather, a men's sweater may be rated at about 35 cubic inches, while a women's sweater for cold weather may be rated at about 25 cubic inches. Similarly, a pair of shoes may be estimated to occupy about 110 cubic inches, while a pair of shorts may occupy about 20 cubic inches. In another example, a camera may have an estimated volume of 80 cubic inches.

In an alternative embodiment, the user may have the option to override the estimated possession volumes 46, and enter a user-specified volume for a selected object, with the input volume to be used by the predetermined selection algorithm 42.

Such possession volume estimates 46 may reflect the entire article of clothing, regardless of whether the clothing is folded, partially folded, or completely unfolded, and regardless of how the clothing is folded. Accordingly, the computerized system 10 and method 12 may be versatile to assist in the packing of luggage for various sizes, shapes, and circumstances which may require articles of clothing to be folded and/or unfolded.

Once the user has completed specifying in the input fields 32 a list of clothing and other objects to be packed for a travel itinerary, the disclosed computerized system 10 and method 12, using the predetermined selection algorithm 42, calculate an estimated total volume of the clothing and/or other objects, and the predetermined selection algorithm 42 then matches the total volume with at least one article of luggage as the selection 50 of luggage having a packing capacity at least equal to or greater than the total volume of objects to be packed.

The selection of the appropriate articles of luggage matching or exceeding the total volume of packed objects is also determined by the predetermined selection algorithm 42 using the additional factors described herein, such as the preference of the user for fewer large bags or assorted medium bags, the presence of hanging garments, etc.

For example, if the user has a relatively large number of hanging garments, such as a predetermined threshold, for example, three hanging garments, the computerized system 10 and method 12, using the predetermined selection algorithm 42 processing the user-inputted information, specifies that a garment bag is to be included in the at least one article of luggage. In addition, if the user specifies a preference for a fewer number of bags to be relatively large, the articles of luggage as the selection 50 of luggage which is determined by the predetermined selection algorithm 42 selects a different set of articles of luggage than if the user had indicated a preference for assorted medium-size bags.

In addition, the number of travelers specified by the user in conjunction with a specified preference for carry-on luggage is processed by the predetermined selection algorithm 42 to match at least one carry-on bag per person. Alternatively, the predetermined selection algorithm 42 may match one carry-on bag per adult, and so avoiding the possible suggestion of having the children or babies in the travel group required to bear carry-on bags, despite a preference of the user to use primarily carry-on bags.

Alternatively, the disclosed computerized system 10 and method 12 may overcompensate the estimated total volume of clothing or possessions in order to insure that the selected articles of luggage are capable of fitting the list of clothing or other objects to be packed. For example, the predetermined selection algorithm 42 may multiple the total volume of clothing or possessions by a predetermined factor of 1.05 to generate an adjusted volume of objects to pack, and then the predetermined selection algorithm 42 matches available articles of luggage to the adjusted volume. Accordingly, in this example embodiment, the computerized system 10 and method 12 includes a 5% cushion to account for variations in the volumes of the specified objects to be packed in case of deviations from the estimated volumes of such objects.

In a further alternative embodiment, the adjustment factor of 1.05 or 5% may be a default value, and the computerized system 10 and method 12 may allow the user to set the adjustment factor to be, for example, 1.10 or 10%.

In another alternative embodiment, the predetermined selection algorithm 42 may use multiple sizes for an expandable article of luggage; that is, the expanded volume in cubic inches and the non-expanded volume may be stored in each memory 18, 40, for example, in the luggage information 44, and both values may be used to optimize the selection 50 of luggage. For example, instead of a combination of a duffel bag and a medium suitcase, the predetermined selection algorithm 42 may replace such items with a single expandable suitcase. In addition, such expandable luggage may be preferred if the user inputs a need for extra space for purchases, such as souvenirs, during travel.

Optionally, the default weight of each item to be packed may also be stored in each memory 18, 40 of the computerized system 10 and method 12, so that the computerized system 10 and method 12 may also determine an estimate of the overall weight of the items to be packed and/or the final weight of the packed luggage, for use in travel situations with weight limits such as airlines.

Once the predetermined selection algorithm 42 generates the selection 50 of at least one article of luggage, the luggage information 44 which may include text descriptions and/or at least one image of such at least one article of luggage in the selection 50 is accessed by each computer 14, 52 and/or the web server 36, and such text descriptions and/or images are output to the user, for example, on the display 26 and/or on a printer of the output device 22. The text descriptions may including manufacturer information, model number, style numbers, or other information identifying each article of luggage recommended as the luggage selection 50 by the disclosed computerized system 10 and method 12.

As described herein, the disclosed computerized system 10 and method 12 may be used by users who already have a variety of articles of luggage or who are prospective purchasers of luggage in a store, through which the disclosed computerized system 10 and method 12 are accessible. The disclosed computerized system 10 and method 12 may be configured to reflect the variety of articles of luggage which the user may use and/or purchase. Accordingly, the user or, for prospective purchasers, the luggage vendor may be required to input a list of the available articles of luggage for storage in the luggage information 44 which is available for use by the predetermined selection algorithm 42.

For example, the user or luggage vendor may input luggage manufacturer names and model numbers to the computer 14, 52, and the computerized system 10 and method 12 store such input luggage designations in the memory 18, 40, respectively, for example, in the luggage information 44 in the data table 48. During luggage selection, the predetermined selection algorithm 42 accesses such stored luggage designations in the luggage information 44 as the universe of available luggage for use and/or purchase to suit the needs of the user or customer. If a prospective customer already has one or more articles of luggage in the list of luggage selected by the predetermined selection algorithm 42, the customer may choose to purchase only the additional luggage not already owned by the customer.

Alternatively, the disclosed computerized system 10 and method 12 may utilize a list of articles of luggage by volume instead of by model number, and so the user must input an estimated or an actual volume associated with a specified article of luggage. The predetermined selection algorithm 42 may then operate using only the volumes to match the total volume of clothing and/or objects to be packed.

The disclosed computerized system 10 and method 12 may also compensate for different types of clothing. For example, the user may specify if a sweater is thick and bulky, or thin and occupying less volume. Also, the clothing may be indexed according to whether the clothing is for men, women, or children, which affects the size of the clothing, and so the predetermined selection algorithm 42 uses different estimates for the same type of clothing but for different sizes or wearers, such a men's sweater or a women's sweater.

In further alternative embodiments, the computerized system 10 and method 12, using the predetermined selection algorithm 42, may provide a suggested lay-out of the clothing within the selected articles 50 of luggage, to assist the user to pack the luggage. In addition, further rules or conditions may be selected by the user to place heavier clothing such as footwear, or even non-clothing objects such as cameras, at the bottom of the luggage.

The predetermined selection algorithm 42 may use predetermined rules implemented in a known computer language and executed by a computer, such as the processor 38 in the web server 36, for processing the user-input information. In addition, the disclosed computerized system 10 and method 12 may use artificial intelligence, genetic algorithms, and/or expert systems to determine the at least one article of luggage as the luggage selection 50 which at least matches the volume of the objects specified by the user-input information. For example, the predetermined selection algorithm 42 may generate a large number of permutations of the volumes of the clothing packed within multiple different sets of a plurality of articles of luggage, and then the predetermined selection algorithm 42 may generate a measurement value of each permutation reflecting the number and sizes of the articles of luggage in each set. The predetermined selection algorithm 42 may then choose the set of articles of luggage having a minimum measurement value, and output the selected set of articles of luggage in the output selection 50 of luggage as the optimum choice of the articles of luggage to be used in the packing of the user-inputted clothing and other objects. The measurement value may be the volume of the selection 50 of luggage, a price for purchasing the selection 50 of luggage, or other known measurements such as cost functions or thresholds to either exceed or to be under.

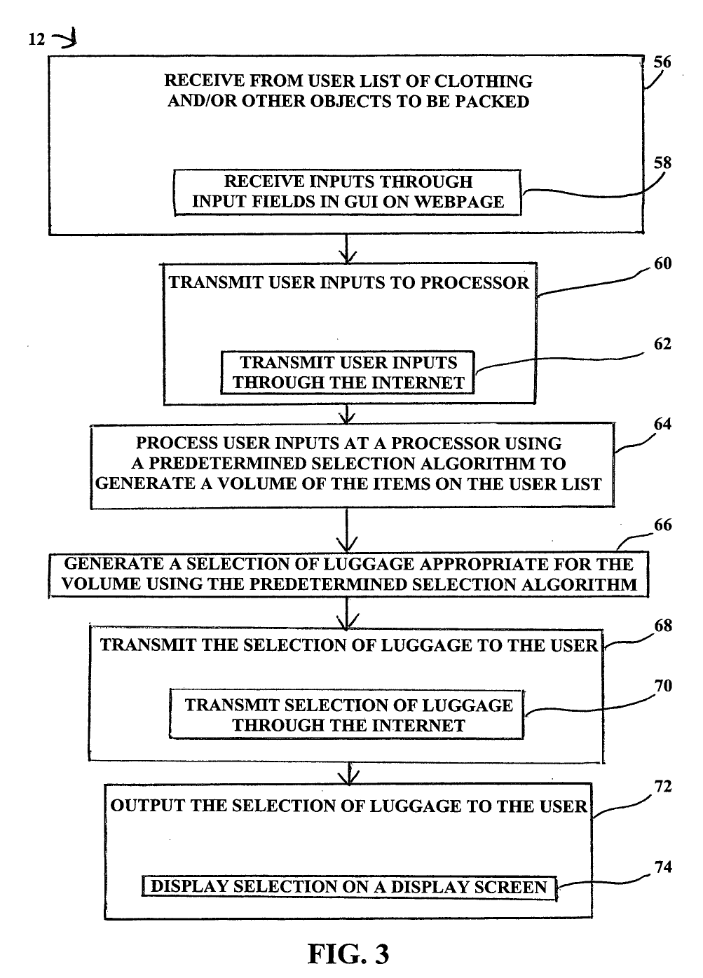

Referring to FIG. 3, the disclosed computerized system 10 implements the method 12 including the step of receiving from the user a list of clothing and/or other objects to be packed in step 56, which may include, in the embodiment of FIG. 1, the step of receiving inputs through the input fields 32 in the GUI 30 on the webpage 24 in step 58. The method 12 then transmits the user inputs to the processor 16 in step 60, which may include, in the embodiment of FIG. 1, the step of transmitting the user inputs to the processor 16 through the Internet 34 in step 62.

The method 12 then processes user inputs at the processor 16 using a predetermined selection algorithm 42 to generate a volume of the items on the user list in step 64, generates a selection 50 of luggage appropriate for the volume using the predetermined selection algorithm 42 in step 66, and transmits the selection 50 of luggage to the user in step 68, which may include, in the embodiment of FIG. 1, the step of transmitting the selection 50 of luggage through the Internet 34 in step 70. The method 12 then outputs the selection 50 of luggage using the output device 22 to the user in step 72, which may include the step of displaying the selection 50 on a display screen of the display 26 in step 74. For the system 10 of FIG. 2, the Internet-related steps 58, 62, and 70 are not performed by the stand-alone computer 52. In alternative embodiments, the step 74 is only performed if a display 26 is provided. Otherwise or in addition, the step 72 may be performed using a printer or other output devices 22 as described herein.

### EXAMPLE OF LUGGAGE SELECTION

The luggage information 44 may store available luggage types, make and model numbers, internal storage dimensions, and characteristics of available luggage including rigidity, weight, etc. The rigidity of the luggage may determine if the luggage can be expanded and/or folded; for example, to allow a given item of luggage such as a duffel bag to be folded for shipment in another item of luggage. Some luggage may be expandable and/or foldable, depending on the manufacturer and model. Examples of luggage information 44 are shown in

TABLE 1

| | | | | | Qualifies |
|---|---|---|---|---|---|
| | | | Internal | | as a |
| | | Dimensions | Volume | Rigid? | Carry-On |
| Type | Model | (cm.³) | (dm.³) | (Y/N) | (Y/N) |
| briefcase | X35 | 4 × 30 × 50 | 6 | yes | yes |
| duffel bag | X47 | 8 × 15 × 100 | 12 | no | yes |
| suitcase | X50 | 8 × 30 × 100 | 24 | yes | no |
| trunk | X100 | 32 × 120 × 200 | 768 | yes | no |

The possession volume estimates 46 may be stored in the data table 48 with types of possessions, variations in dimensions if the possession is foldable such as clothing, estimated volume, and whether the possession is foldable or fixed in shape, such as a hair brush. Examples of possessions and possession volume estimates 46 are shown in Table 2:

TABLE 2

| | | | Rigid ? |
|---|---|---|---|
| Type | Dimensions (cm.³) | Estimated Volume (dm.³) | (Y/N) |
| shirt | 2 × 30 × 50; | 3 | no |
| | 4 × 15 × 50 | | |
| pants | 2 × 30 × 100; | 6 | no |
| | 4 × 15 × 100; | | |
| | 4 × 30 × 50 | | |
| hair brush | 2 × 8 × 20 | .32 | yes |
| camera | 10 × 15 × 15 | 2.25 | yes |

In an example operation of the system 10 and method 12, a user may input into the input device 20 a list of items to pack, such as three shirts, two pairs of pants, and a hair brush, with such items entered into the input fields 32. The system 10 and method 12, using the possession information in the input fields 32, uses the selection algorithm 42 to access the possession volume estimates 46 to retrieve the corresponding estimated volumes of each item, and to add the appropriate multiples of the estimated volumes to generate an overall volume estimate. For the example list of three shirts, two pairs of pants, and a hair brush, the estimated volume is: (3 shirts×3 dm³)+(2 pants×6 dm³)+(1 hairbrush×0.32 dm³.

The system 10 and method 12, the using selection algorithm 42 and the estimated volume of 21.32 dm³, generates numerous permutations of luggage having a total volume of at least the estimated volume using the luggage information 44 in Table 1. For example, proposed selections of luggage and their associated total volumes are shown in Table 3:

TABLE 3

| Proposed | | Combined |
|---|---|---|
| Selection Index | Composition of Selection | Volume (dm.³) |
| A | 4 briefcases | 24 |
| B | 2 briefcases + 1 duffel bag | 24 |
| C | 2 duffel bags | 24 |
| D | 1 suitcase | 24 |
| E | 1 trunk | 768 |

with each proposed selection having at least the required volume of 21.32 dm³ for the specified items to pack.

The system 10 and method 12, using the selection algorithm 42, then generates an optimal selection from among the proposed selections in Table 3 to be the selection 50 of luggage. The optimal selection may be determined by a default criteria, such as minimization of the number of items of luggage with the minimum of wasted space. Other criteria may include the presence of any carry-on luggage for use in travel on airplanes, buses, and trains; for example, to avoid checking-in luggage and the potential loss of checked-in luggage. Additional criteria may include an indication from the user to provide extra room, for example, for bringing back souvenirs from the travel. In addition, the system 10 and method 12, using the selection algorithm 42, may take into account the maximum dimensions of the luggage. For example, if the user inputs the need to travel with a musical instrument or a pair of skis over 100 cm. long, then the system 10 and method 12, using the selection algorithm 42, disregards the smaller briefcase, suitcase, and duffel bag, and instead generates the trunk as the selection 50 of luggage.

In the present example of needing to pack three shirts, two pairs of pants, and a hair brush, using the default criteria of minimization of the number of items, the system 10 and method 12 generates selection D in Table 3 to recommend to the user to select only one suitcase instead of using an oversized trunk. However, if the user indicates a preference for carry-on luggage, the system 10 and method 12 generates selection B in Table 3 to recommend to the user to select two duffel bags, a minimal number of carry-on luggage items, as opposed to selections A and C which have four and three items carry-on luggage items, respectively. In addition, if the user indicates a need for excess room for souvenirs, the system 10 and method 12 generates selection E in Table 3 to recommend to the user to select a trunk. It is understood that many different shapes and sizes of luggage may be stored in the luggage information 44, for example, a large suitcase having a volume between 24 dm.³ of the smaller suitcase in Table 1 and 768 dm.³ of the trunk in Table 1, as well as an elongated duffel bag or carry case to accommodate skis or musical instruments.

While the preferred embodiment of the present invention has been shown and described herein, it will be obvious that such embodiment is provided by way of example only. Numerous variations, changes and substitutions will occur to those skilled in the art without departing from the invention herein. Accordingly, it is intended that the invention be limited only by the spirit and scope of the appended claims.

What is claimed is:

1. A computerized system for selecting luggage for a user, the system comprising:
an input device allowing the user to enter travel information, including possession data corresponding to possessions associated with the user;
an output device for outputting a proposed luggage selection for storing the possessions; and
a first computer including:
a memory for storing the travel information; and
a processor for processing the travel information including the possession data for determining an estimated total volume of the possessions, for using a predetermined selection algorithm for determining, from the estimated volume, at least one article of luggage to be the proposed luggage selection, and for transmitting the proposed luggage selection to be output by the output device.

2. The computerized system of claim 1, wherein the first computer is operatively connected to the input device and to the output device.

3. The computerized system of claim 1, further comprising:
a second computer operatively connected to the input device and to the output device; and
wherein the first computer is a web server operatively connected to the second computer through the Internet to transmit the proposed luggage selection to the second computer to be output by the output device.

4. The computerized system of claim 1, wherein the output device is a display for displaying the proposed luggage selection.

5. The computerized system of claim 4, wherein the processor generates a graphic user interface (GUI) including at least one input field on the display for facilitating user entry of the travel information.

6. The computerized system of claim 5, wherein the GUI displays a web page having the at least one input field.

7. The computerized system of claim 6, wherein the GUI includes a browser for displaying the web page.

8. The computerized system of claim 1, wherein the memory stores a data table including luggage information identifying a plurality of luggage types from which the at least one article of luggage is chosen by the predetermined selection algorithm.

9. The computerized system of claim 1, wherein the memory stores a plurality of volume estimates; and
wherein the processor, responsive to the possession data, matches each of the possessions with a corresponding volume estimate from the plurality of volume estimates for generating the estimated total volume of the possessions.

10. A computerized system for selecting luggage for a user, the system comprising:
an input device allowing the user to enter travel information, including possession data corresponding to possessions associated with the user, with the possessions including at least one article of clothing;
a display for displaying to the user a proposed luggage selection for storing the possessions including the at least one article of clothing; and
a first computer including:
a memory for storing the travel information; and
a processor for processing the travel information including the possession data for determining an estimated total volume of the possessions, including the at least one article of clothing, for using a predetermined selection algorithm for determining, from the estimated volume, at least one article of luggage to be the proposed luggage selection, and for transmitting the proposed luggage selection to be displayed to the user by the display.

11. The computerized system of claim 10, wherein the first computer is operatively connected to the input device and to the display, with the first computer using the processor for generating the proposed luggage selection independent of the Internet.

12. The computerized system of claim 10, further comprising:
a second computer operatively connected to the input device and to the display; and
wherein the first computer is a web server operatively connected to the second computer through the Internet to transmit the proposed luggage selection to the second computer to be displayed by the display.

13. The computerized system of claim 12, wherein the processor generates a graphic user interface (GUI) including at least one input field on the display for facilitating user entry of the travel information.

14. The computerized system of claim 13, wherein the GUI displays a web page having the at least one input field.

15. The computerized system of claim 14, wherein the GUI includes a browser for displaying the web page on the display.

16. The computerized system of claim 10, wherein the memory stores a data table including luggage information identifying a plurality of luggage types from which the at least one article of luggage is chosen by the predetermined selection algorithm for storing the at least one article of clothing.

17. The computerized system of claim 10, wherein the memory stores a plurality of volume estimates; and
wherein the processor, responsive to the possession data, matches each of the possessions with a corresponding volume estimate from the plurality of volume estimates for generating the estimated total volume of the possessions, including the at least one article of clothing.

18. A computerized method for selecting luggage for a user, the method comprising the steps of:
receiving travel information at an input device from a user, wherein the travel information includes possession data corresponding to possessions associated with the user, with the possessions including at least one article of clothing;
storing the travel information in a memory of a first computer;
processing the travel information including the possession data using a processor of the first computer;
determining an estimated total volume of the possessions, including the at least one article of clothing;
generating at a processor, using a predetermined selection algorithm applied to the estimated total volume, a proposed luggage selection including at least one article of luggage;
transmitting the proposed luggage selection; and
displaying on a display to the user the transmitted proposed luggage selection for storing the possessions including the at least one article of clothing.

19. The computerized method of claim 18, further comprising the steps of:
operatively connecting the first computer to the input device;
operatively connecting the first computer to the display; and
wherein the step of generating the proposed luggage selection includes the step of:
generating the proposed luggage selection at the first computer using the processor independent of the Internet.

20. The computerized method of claim 18, further comprising the steps of:
operatively connecting a second computer to the input device;
operatively connecting the second computer to the display; and
wherein the first computer is a web server operatively connected to the second computer through the Internet to transmit the proposed luggage selection to the second computer to be displayed by the display.
